(19) United States
(12) Patent Application Publication
(10) Pub. No.: US 2009/0174114 A1
(43) Pub. Date: Jul. 9, 2009

(54) METHOD OF MAKING COMPOSITE BASEBALL BAT

(76) Inventor: YUNG-HSIUNG CHEN, (US)

Correspondence Address: LEONG C LEI, PMB # 1008, 1867 YGNACIO VALLEY ROAD, WALNUT CREEK, CA, 94598, US

(21) Appl. No.: 11/968,661

(22) Filed: Jan. 3, 2008

(51) Int. Cl. B29D 23/00; A63B 59/06

(52) U.S. Cl. 264/263; 264/271.1; 473/567

(57) ABSTRACT

First, fibers of a single material or of mixed materials are knitted or woven into a single-layer fiber tube. Then, two or more fiber tubes thus formed are threaded layer-by-layer over a mandrel and the two ends of the fiber tubes are fastened. The assembly is then submerged in a vacuumed or pressurized tank of uncured resins, so that the resins could permeate evenly into the fiber tubes. The assembly is then thermally cured and the cured fiber tubes are removed from the mandrel. The fiber tubes are then placed in a mold and molded together with a knob and a cap at its both ends to make a composite baseball bat.

### (a) TECHNICAL FIELD OF THE INVENTION

The present invention generally relates to baseball bats, and more particularly to a method of making composite baseball bats.

### (b) DESCRIPTION OF THE PRIOR ART

Compared to aluminum, wood, and other materials used to make baseball bats, composite materials are lighter, stiffer and stronger.

A conventional composite baseball bat is made in accordance with the steps depicted in the flow chart of FIG. 1. First of all, fibers are impregnated with uncured resins and then knitted or woven into pieces of cloth. These pieces of cloth are then cut into sheets of various shapes.

As shown in FIG. 2, these fiber sheets 1 are layered manually over a mandrel 2. The layered sheets 1 are then heated to cure the resins and, after that, the mandrel 2 is removed. The layered sheets 1 now form a tubular body. The tubular body is then placed in a mold and molded together with a knob and a cap at its both ends. A composite baseball bat is thus made.

When layering the sheets 1 over the mandrel 2, it is required that the sheets 1 are properly overlapped. Otherwise, the baseball bat would have inferior strength at where there is too little or improper overlapping. Therefore, only experienced workers are capable of getting the task done correctly and, thus, this is not only a laborious but also costly process.

### SUMMARY OF THE INVENTION

The primary purpose of the invention is to provide a novel method of making composite baseball bats that can achieve high-performance baseball bats with reduced production time and cost.

According to the present method, fibers of a single material or of mixed materials are knitted or woven into a single-layer tubular form. Then, two or more fiber tubes thus formed are threaded layer-by-layer over a mandrel and the two ends of the fiber tubes are fastened by unwoven clothes. The assembly of the fiber tubes and the mandrel is then submerged in a vacuumed or pressurized tank of uncured resins, so that the resins could permeate evenly into the fiber tubes. The assembly is then taken out of the tank and thermally cured. Finally, the cured fiber tubes are removed from the mandrel and, according to a desired length, the two ends of fiber tubes are cut appropriately. The fiber tubes are then placed in a mold and molded together with a knob and a cap at its both ends to make the baseball bat.

The foregoing objectives and summary provide only a brief introduction to the present invention. To fully appreciate these and other objects of the present invention as well as the invention itself, all of which will become apparent to those skilled in the art the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a flow chart showing the steps of a conventional method of making composite baseball bats.

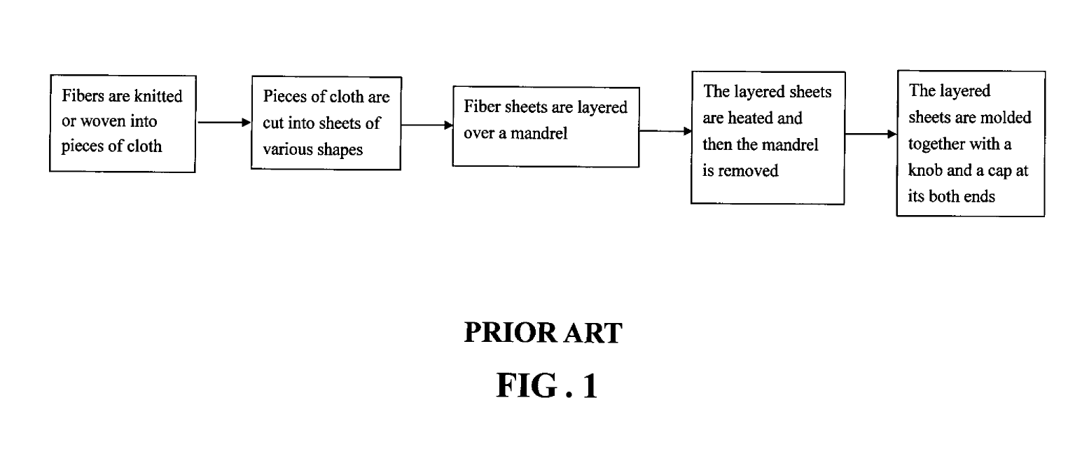

FIG. 2 is a schematic diagram showing how fiber sheets are layered over a mandrel in the conventional method of FIG. 1.

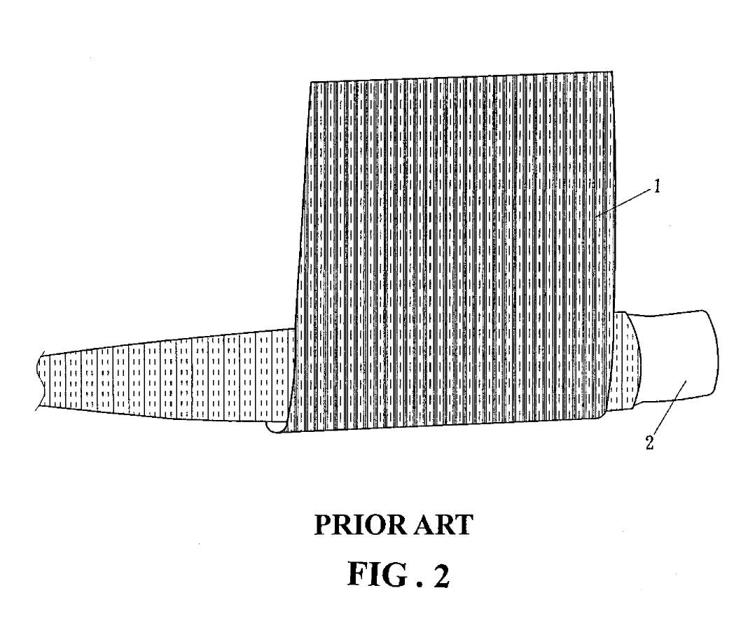

FIG. 3 is a flow chart showing the steps of a method of making composite baseball bats according to an embodiment of the present invention.

FIG. 4 is a schematic diagram showing how fiber tubes are threaded over a mandrel in the method of FIG. 3.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

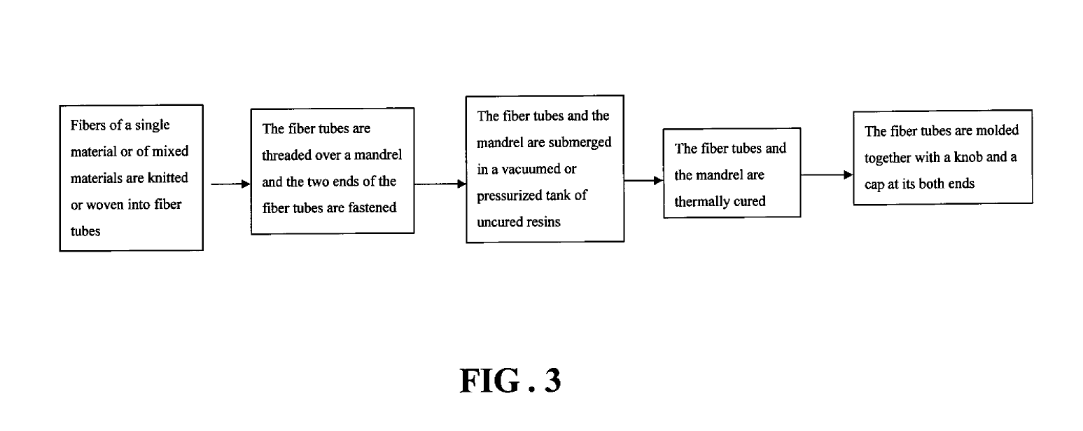

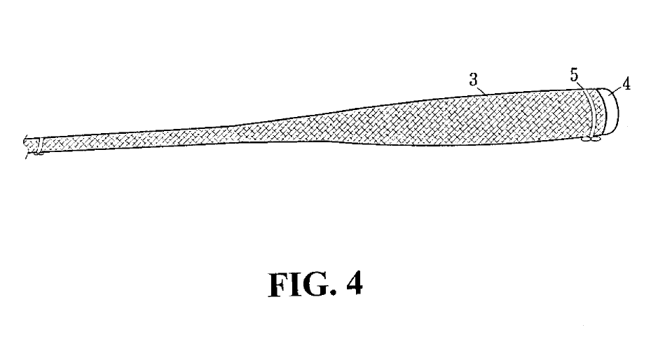

As shown in FIG. 3, fibers of a single material or of mixed materials are knitted or woven in advance into a single-layer tubular form. The fiber tube thus formed has 24˜120 fibers and the fiber orientations are angled at 5˜85 degrees. Optionally, at least one of a metallic material, a rubber material, a fiber reinforced plastic material, and a wooden material is blended in at least one of the fiber tube. Then, as shown in FIG. 4, two or more fiber tubes 3 thus formed are threaded layer-by-layer over a mandrel 4 having a baseball-bat shape and the two ends of the fiber tubes 3 are fastened by unwoven clothes 5 to the mandrel 4.

The assembly shown in FIG. 4 is then submerged in a vacuumed or pressurized tank of uncured resins, so that the resins could permeate evenly into each of the fiber tubes 3. The assembly is then taken out of the tank and thermally cured. Finally, the cured fiber tubes 3 are removed from the mandrel 4 and, according to a desired length, the two ends of fiber tubes 3 are cut appropriately. The fiber tubes 3 are then placed in a mold and molded together with a knob and a cap at its both ends to make a baseball bat, just like the conventional method.

The present invention enjoys a number of advantages. First, the fiber tubes 3 could be produced in a mass production manner by automated machinery. Secondly, as the fiber tubes 3 have a uniform structure, strength of the baseball bats thus made is uniform across the bat, unlike the conventional approach where the strength of the bat differs depending on how the fiber sheets are layered. Also, as such, the present method does not require the expertise of experience workers and even novice workers could produce high-quality baseball bats. Both the production time and cost could be significantly reduced.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A method of making a composite baseball bat, comprising the steps of:
providing a plurality of fiber tubes, each having a single layer of fibers woven into a tubular form; and
threading said fiber tubes layer-by-layer over a mandrel;
fastening two ends of said fiber tubes;
submerging said fiber tubes and said mandrel in a vacuumed or pressurized tank of resins;
removing said fiber tubes from said mandrel;
cutting said fiber tubes into an appropriate length; and
molding said fiber tubes into said composite baseball bat.

2. The method according to claim 1, wherein each fiber tube has 24˜120 fibers.

3. The method according to claim 1, wherein said fibers of each fiber tube are angled at 5˜85 degrees.

4. The method according to claim 1, wherein said fibers of each fiber tube are made of a single material.

5. The method according to claim 1, wherein said fibers of each fiber tube are made of different materials.

6. The method according to claim 1, wherein at least one of a metallic material, a rubber material, a fiber reinforced plastic material, and a wooden material is blended in a fiber tube.
